(19) United States
(12) Patent Application Publication
(10) Pub. No.: US 2010/0250044 A1
(43) Pub. Date: Sep. 30, 2010

(54) VEHICLE DATA INPUT CONTROL METHOD

(75) Inventors: Bilal Alasry, Dearborn, MI (US); Ahmed Abubaker, Dearborn, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/414,146

(22) Filed: Mar. 30, 2009

(51) Int. Cl. G06F 19/00

(52) U.S. Cl. 701/29

(57) ABSTRACT

A method of controlling data input to a vehicle data input system determines a speed of a vehicle, determines an occupancy state of a non-driver position of the vehicle based on a presence of a non-driver in the non-driver position, determines a behavior of a driver based on input from a driver behavior system, and adjusts an input functionality of a vehicle data input system based on the vehicle speed, the occupancy state of the passenger, and the behavior of the driver.

### FIELD

The present invention relates generally to vehicle display systems and interfaces, and more particularly, to a method of controlling a vehicle display system and interface that, while a vehicle is moving, prevents a driver from inputting data but permits a passenger to input data.

### BACKGROUND

This section provides background information related to the present disclosure which is not necessarily prior art. Vehicle data input systems are known in the art and may provide input and display devices for displaying and inputting data. Such devices may be affiliated with navigation information, climate control preferences, audio settings, video settings, communication data, and the like. Such vehicle data input system may be installed at or around the center of a vehicle instrument panel to permit a user of the vehicle data input system, such as a driver or a front passenger, to view and input data. While such vehicle data input systems have generally been satisfactory for their given applications, they are not without their share of limitations. One limitation relates to the inability of systems to accept the input of information while a vehicle is moving.

### SUMMARY

This section provides a general summary of the disclosure, and is not a comprehensive disclosure of its full scope or all of its features. A method of controlling data input to a vehicle data input system may entail determining a speed of a vehicle, determining an occupancy state of a passenger position of the vehicle based on a presence of a passenger in the passenger position and determining a behavior of a driver based on input from a driver behavior system. The method may then adjust an input functionality of a vehicle data input system based on the vehicle speed, the occupancy state of the passenger, and the behavior of the driver. Determining the behavior of the driver may entail determining whether the driver is controlling the vehicle. Moreover, the method may involve adjusting the input functionality of the vehicle data input system by activating a drive enforcement state to reduce the input functionality and also releasing the drive enforcement state to provide full input functionality.

Other aspects of the method may involve activating the drive enforcement state when the vehicle speed is greater than a predetermined speed threshold and the occupancy state indicates no presence of a passenger. The method may further involve activating the drive enforcement state when the vehicle speed is greater than the predetermined speed threshold and the driver is not controlling the vehicle. Still yet, the method may proceed by releasing the drive enforcement state when the vehicle speed is less than or equal to the predetermined speed threshold. Moreover, the method may involve releasing the drive enforcement state when the vehicle speed is greater than the predetermined speed threshold, the occupancy state indicates the presence of a passenger, and the driver is controlling the vehicle.

In still other features, the method may determine whether the driver is controlling the vehicle based on input from a first driver input device and a second driver input device, wherein the first and second driver input devices are accessible by the driver of the vehicle. A steering wheel of the vehicle may be provided with the first driver input device and the second driver input device such that the driver is required to use a first hand to actuate the first driver input device and a second hand to actuate the second driver input device. A gearshift may be provided with the first driver input device and the steering wheel may be provided with the second driver input device. The method may determine the passenger occupancy state based on a signal from an occupant classification system provided with the passenger position.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure. The present disclosure will become more fully understood from the detailed description and the accompanying drawings, wherein:

FIG. 1 is a functional block diagram of an exemplary vehicle data input system according to the principles of the present disclosure;

FIG. 2 depicts an exemplary vehicle provided with the exemplary vehicle data input system according to the principles of the present disclosure; and

FIG. 3 is a flowchart depicting exemplary steps of a method of the present disclosure.

Corresponding reference numerals indicate corresponding parts throughout the several views of the drawings.

### DETAILED DESCRIPTION

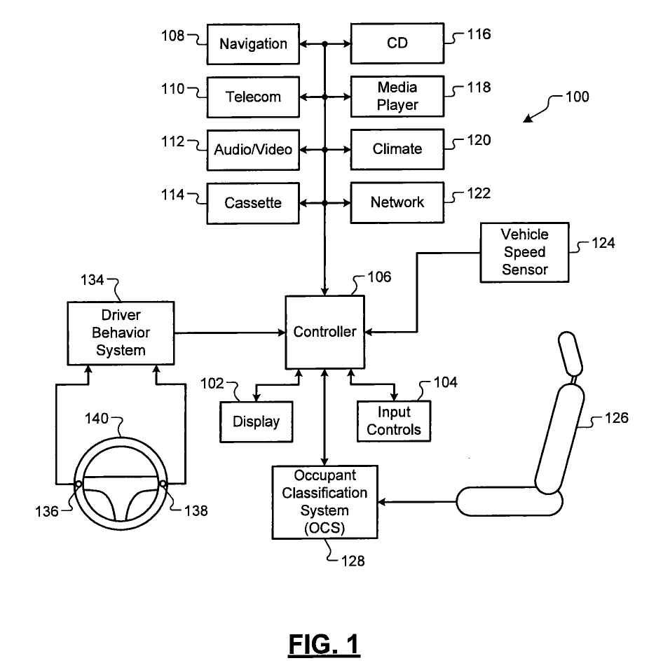

The following description is merely exemplary in nature and is in no way intended to limit the disclosure, its application, or uses. For purposes of clarity, the same reference numbers will be used in the drawings to identify similar elements. Example embodiments will now be described more fully with reference to FIGS. 1-3.

As a safety measure, a vehicle data input system may be designed so as not to permit some input functionality, such as complex input operations, which may include retrieving a map, setting a desired destination, or inputting a telephone number or contact information, while a vehicle is being driven. The vehicle data input system may permit simple input operations while the vehicle is being driven. While a passenger is present in the vehicle and a driver is controlling the vehicle, the vehicle data input system may be designed to permit complex input operations by the passenger and not the driver. Therefore, the input functionality may be adjusted to permit complex input operations while the vehicle is being driven.

The method of the present disclosure may adjust the input functionality of the vehicle data input system based on vehicle operating conditions, presence of a passenger, and behavior of a driver. The method may activate and release a drive enforcement state of the vehicle data input system. When the drive enforcement state is activated, the functionality of the vehicle data input system may be reduced by blocking complex input operations by a user of the vehicle data input system. When the drive enforcement state is released, the vehicle data input system may be fully functional and permit complex input operations by the user. The complex input operations may include entering a destination address for a navigation system, entering a phone number for a phone system, and other complex input operations that may require increased attention by the user.

The method of the present disclosure determines vehicle operating conditions such as vehicle speed. The method determines whether a passenger is present in the front passenger seat and whether a driver is controlling the vehicle. The method activates and releases the drive enforcement state of the vehicle data input device based on the vehicle operating conditions, the presence of a passenger in the front passenger seat, and whether the driver is controlling the vehicle.

Referring now to FIG. 1, a functional block diagram of an exemplary vehicle data input system 100 according to the principles of the present disclosure is shown. The vehicle data input system 100 may include a display 102 and input controls 104. The display 102 may include a CRT display, a liquid crystal display, or any other similar type of display used in motor vehicles, including a touch screen display. The input controls 104 may include input devices for alternating between navigation inputs, audio/video inputs, telephone inputs, and the like. The input controls 104 may include touch screen controls provided with the display 102 that enable a user to perform map retrieval and destination selection, enter telephone numbers, addresses and other functions. The input controls 104 may be provided on or near the display 102.

The vehicle data input system 100 may include a controller 106 that coordinates inputs from the input controls 104 with activation of various control units. The control units may include, but are not limited to, a navigation control unit 108, a telecommunications (telecom) control unit 110, an audio/video control unit 112, a cassette control unit 114, a CD control unit 116, a media player control unit 118, a climate control unit 120, and a vehicle network control unit 122. The controller 106 may cause the display 102 to display data related to each unit based on input to the input controls 104. The user may control input operations using the input controls 104. The input operations may include simple input operations and complex input operations.

The navigation control unit 108 may output information such as maps, destinations, addresses, traffic information, and route profiles to the display 102. The navigation control unit 108 may determine the vehicle location based on electronic maps and information from a global positioning system (GPS) receiver. The complex input operations may include entering a destination address. The simple input operations may include selecting a previously entered destination address.

The telecom control unit 110 may output information such as outgoing and incoming phone calls of a vehicle phone. The complex input operations may include entering a phone number, contact information, and the like. The simple operations may include answering an incoming phone call. The audio/video control unit 112 may control selection of a radio station and various audio/video levels. The complex input operations may include entering information about the radio station and adjusting audio equalizer information. The simple input operations may include selecting a radio station or adjusting audio volume.

The cassette control unit 114, CD control unit 116, and media player control unit 118 may control the playing of cassette tapes, CDs, and media such as DVDs, Blu-ray discs and other digital media, respectively. The CDs, DVDs, and/or Blu-ray discs may be used by the navigation control unit 108 to input information such as maps and destinations. The complex input operations may include loading cassette tapes, CDs, DVDs, and Blu-ray discs. The simple input operations may include selecting tape positions or CD, DVD, and Blu-ray tracks. The climate control unit 120 may output climate control information to the display 102. The vehicle network control unit 122 may control a personal area network for connecting various wireless devices to a vehicle network. The complex input operations may include synchronizing or pairing the wireless devices with the vehicle network.

The controller 106 may receive signals based on operating conditions of the vehicle. For example only, the controller 106 may receive a vehicle speed signal from a vehicle speed sensor 124 or an engine controller (not shown). When the vehicle speed is greater than a threshold vehicle speed, the controller 106 may activate a drive enforcement state of the vehicle data input system 100 to prevent complex input operations. The drive enforcement state reduces input functionality of the vehicle data input system 100 by preventing complex input operations while allowing simple input operations. When the drive enforcement state is released, full input functionality of the vehicle data input system 100 may be permitted. Full input functionality may include both complex and simple input operations.

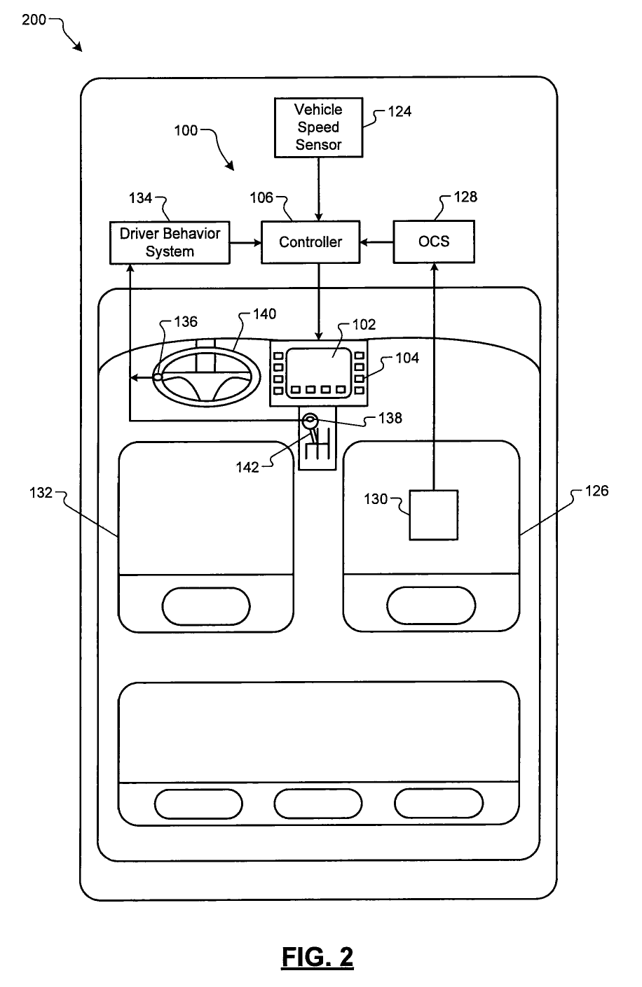

Referring now to FIGS. 1 and 2, an exemplary vehicle data input system 100 is provided in a vehicle 200. The controller 106 may receive passenger occupancy information based on the presence of a passenger, and more specifically, a non-driver passenger, in a front passenger seat 126 of the vehicle 200. For example only, an occupant classification system (OCS) 128 may determine an occupancy status of the front passenger seat 126. The occupancy status may indicate whether a passenger is present in the front passenger seat 126. The OCS 128 may determine the occupancy status based on input from a weight sensor 130. The OCS 128 may determine the occupancy status based on an image captured by a camera (not shown) directed towards the front passenger seat 126. The OCS 128 may determine the occupancy status based on a temperature of the front passenger seat 126 (not shown). The OCS 128 may determine the occupancy status of the front passenger seat 126 and transmit the occupancy status to the controller 106.

A driver behavior system 134 may determine whether a driver is controlling the vehicle 200 and send a driver behavior signal to the controller 106. The driver behavior system 134 may determine whether the driver is using two hands to control the vehicle 200. For example only, the driver behavior system 134 may include a first driver input device 136 and a second driver input device 138 that may be actuated by the driver while controlling the vehicle 200. The driver behavior system 134 may signal to the controller 106 that the driver is using both hands to control the vehicle 200 when both the first and second driver input devices 136, 138, respectively, are actuated by the driver.

In FIG. 1, a steering wheel 140 of the vehicle may be provided with the first and second driver input devices 136, 138. The first driver input device 136 is spaced apart from the second driver input device 138 such that the driver may not actuate both driver input devices 136, 138 with one hand. In FIG. 2, the steering wheel 140 may be provided with the first driver input device 136 and a gearshift 142 may be provided with the second driver input device 138. The driver behavior system 134 may receive signals from various driver input devices that may include pressure-sensing devices, bend-sensing devices, temperature-sensing devices, and any other devices that may detect whether the driver is in control of the vehicle 200.

When the driver actuates both the first and the second driver input devices 136, 138, the driver behavior system 134 may indicate to the controller 106 that the driver is controlling the vehicle 200. When the driver actuates less than both of the driver input devices 136, 138, the driver behavior system 134 may indicate to the controller 106 that the driver is not controlling the vehicle 200.

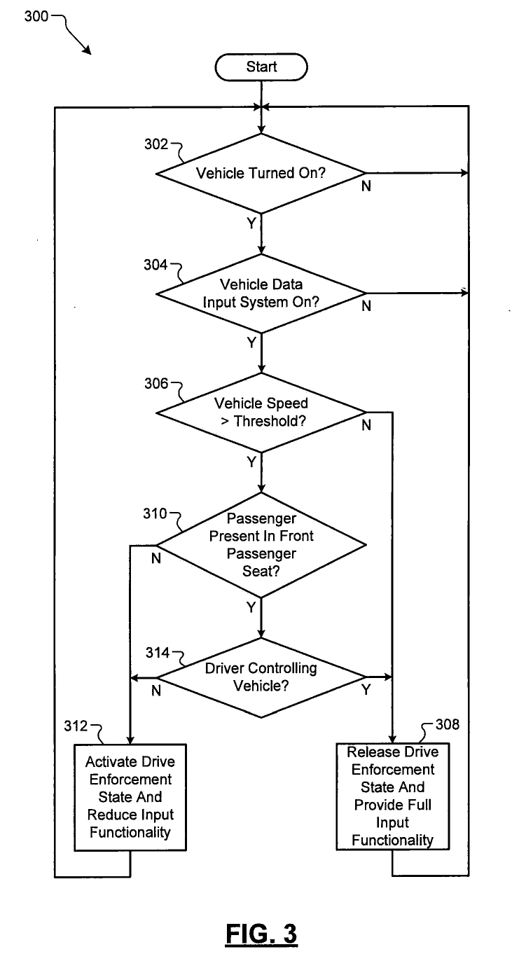

Referring now to FIG. 3, a flowchart 300 depicts exemplary steps of the method of the present disclosure. In step 302, it is determined whether the vehicle 200 is turned on. For example only, it may be determined that the vehicle 200 is turned on when engine speed is greater than a threshold engine speed (RPM). In step 304, it is determined whether the vehicle data input system 100 is turned on. When the vehicle 200 and vehicle data input system 100 are both turned on, processing continues to step 306.

In step 306, it is determined whether vehicle speed is greater than a threshold speed. For example only, the threshold speed may be a vehicle speed below which the driver may safely input complex operations to the vehicle data input system 100. For example only, the threshold speed may be less than or equal to approximately 7 kph. While the vehicle speed is less than or equal to the threshold speed in step 308, the controller 106 may release the vehicle data input system 100 from the drive enforcement state. Operation of the vehicle data input system 100 may include full input functionality. While the vehicle speed is greater than the threshold speed, processing continues to step 310.

In step 310, it is determined whether a passenger is present in the front passenger seat 126. For example only, the OCS 128 may determine the occupancy state of the front passenger seat 126. While a passenger is not present in the front passenger seat 126, the OCS 128 may indicate to the controller 106 that a passenger is not present. The controller 106 may operate the vehicle data input system 100 in the drive enforcement state in step 312. Operation of the vehicle data input system 100 may include reduced input functionality. While a passenger is seated in the front passenger seat, the OCS 128 may indicate to the controller 106 that a passenger is present. Processing may continue to step 314. In step 314, it is determined whether the driver is controlling the vehicle 200. The driver behavior system 134 may indicate to the controller 106 whether the driver is controlling the vehicle 200 based on inputs from the driver input devices 136, 138.

While the driver actuates both driver input devices 136, 138, the driver behavior system 134 indicates to the controller 106 that the driver is controlling the vehicle 200. Processing continues to step 308, and the controller 106 may release the vehicle data input system 100 from the drive enforcement state. Operation of the vehicle data input system 100 may include full input functionality.

While the driver actuates less than both driver input devices 136, 138, the driver behavior system 134 indicates to the controller 106 that the driver is not controlling the vehicle 200. Processing continues to step 312, and the controller 106 may operate the vehicle data input system 100 in the drive enforcement state. Operation of the vehicle data input system 100 may include reduced input functionality.

The present method reduces the possibility of a driver manipulating the driver behavior system 134 in order to override the locked state. For example only, if the driver input devices 136, 138 include mechanical switches, the driver may use clamps or other devices to actuate the switches instead of placement of the driver's hands while controlling the steering wheel 140 and/or gearshift 142. If the driver input devices 136, 138 include electrical components (transistors, etc.), the driver may attach a circuit to actuate the driver input devices 136, 138. To reduce the possibility of manipulation by the driver, the OCS 128 may confirm whether a passenger (other than the driver) is actually inside the vehicle 200.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A method comprising:
determining a speed of a vehicle;
determining an occupancy state of a front passenger seat of the vehicle based on a presence of a passenger in the front passenger seat;
determining a behavior of a driver based on input from a driver behavior system, wherein the behavior includes whether the driver is controlling the vehicle; and
adjusting an input functionality of a vehicle data input system based on the vehicle speed, the occupancy state of the front passenger seat, and the behavior of the driver.

2. The method of claim 1, wherein adjusting the input functionality of the vehicle data input system includes activating a drive enforcement state to reduce the input functionality and releasing the drive enforcement state to provide full input functionality.

3. The method of claim 2, further comprising:
activating the drive enforcement state when the vehicle speed is greater than a predetermined speed threshold and the occupancy state indicates no presence of a passenger in the front passenger seat.

4. The method of claim 2, further comprising:
activating the drive enforcement state when the vehicle speed is greater than a predetermined speed threshold and the driver is not controlling the vehicle.

5. The method of claim 2, further comprising:
releasing the drive enforcement state when the vehicle speed is less than or equal to a predetermined speed threshold.

6. The method of claim 2, further comprising:
releasing the drive enforcement state when the vehicle speed is greater than a predetermined speed threshold, the occupancy state indicates the presence of a passenger in the front passenger seat, and the driver is controlling the vehicle.

7. The method of claim 1, further comprising:
determining whether the driver is controlling the vehicle based on input from a first driver input device and a second driver input device, wherein the first and second driver input devices are accessible by the driver of the vehicle.

8. The method of claim 7, wherein a steering wheel of the vehicle is provided with the first driver input device and the second driver input device such that the driver is required to use a first hand to actuate the first driver input device and a second hand to actuate the second driver input device.

9. The method of claim 7, wherein a gearshift is provided with the first driver input device and a steering wheel is provided with the second driver input device.

10. The method of claim 1, further comprising:
determining the passenger occupancy state based on a signal from an occupant classification system provided with the front passenger seat.

11. A method comprising:
determining a speed of a vehicle;
determining an occupancy state of a non-driver seat of the vehicle based on a presence of a non-driver in the non-driver seat, wherein the occupancy state is based on a signal from an occupant classification system provided with the non-driver seat;
determining whether the driver is controlling the vehicle based on input from a first driver input device and a second driver input device, wherein the first and second driver input devices are accessible by the driver of the vehicle; and
adjusting an input functionality of a vehicle data input system based on the vehicle speed, the occupancy state of the non-driver seat, and the behavior of the driver, wherein adjusting the input functionality of the vehicle data input system includes activating a drive enforcement state to reduce the input functionality and releasing the drive enforcement state to provide full input functionality.

12. The method of claim 11, further comprising:
activating the drive enforcement state when the vehicle speed is greater than a predetermined speed threshold and the occupancy state indicates no presence of a non-driver in the non-driver seat; and
releasing the drive enforcement state when the vehicle speed is less than or equal to a predetermined speed threshold.

13. The method of claim 12, further comprising:
activating the drive enforcement state when the vehicle speed is greater than a predetermined speed threshold and the driver is not controlling the vehicle; and
releasing the drive enforcement state when the vehicle speed is less than or equal to a predetermined speed threshold.

14. The method of claim 13, further comprising:
releasing the drive enforcement state when the vehicle speed is greater than a predetermined speed threshold, the occupancy state indicates the presence of a non-driver in the non-driver seat, and the driver is controlling the vehicle.

15. The method of claim 14, wherein at least one of a steering wheel and a gearshift of the vehicle is provided with at least one of the first driver input device and the second driver input device such that the driver is required to use a first hand to actuate the first driver input device and a second hand to actuate the second driver input device.

16. A method comprising:
determining a speed of a vehicle;
determining an occupancy state of a front non-driver seat of the vehicle based on a presence of a non-driver in the front non-driver seat;
determining a behavior of a driver based on a first driver input device and a second driver input device, wherein the first and second driver input devices are accessible by the driver of the vehicle; and
adjusting an input functionality of a vehicle data input system based on the vehicle speed, the occupancy state of the front non-driver seat, and actuation of the first and second driver input devices by the driver, wherein adjusting the input functionality includes activating a drive enforcement state to reduce the input functionality and releasing the drive enforcement state to provide full input functionality.

17. The method of claim 16, further comprising:
activating the drive enforcement state when the vehicle speed is greater than a predetermined speed threshold and the occupancy state indicates no presence of a non-driver in the non-driver seat; and
releasing the drive enforcement state when the vehicle speed is less than or equal to a predetermined speed threshold.

18. The method of claim 17, further comprising:
activating the drive enforcement state when the vehicle speed is greater than a predetermined speed threshold and the driver is not controlling the vehicle; and
releasing the drive enforcement state when the vehicle speed is less than or equal to a predetermined speed threshold.

19. The method of claim 18, further comprising:
releasing the drive enforcement state when the vehicle speed is greater than a predetermined speed threshold, the occupancy state indicates the presence of a non-driver in the non-driver seat, and the driver is controlling the vehicle.

20. The method of claim 19, wherein the driver is required to use a first hand to actuate the first driver input device and a second hand to actuate the second driver input device.
